(19) United States
(12) Patent Application Publication
(10) Pub. No.: US 2026/0082424 A1
(43) Pub. Date: Mar. 19, 2026

(54) SYSTEMS AND METHODS FOR MEASUREMENT GAP USAGE SIGNALING ENHANCEMENTS

(71) Applicant: APPLE INC., Cupertino, CA (US)

(72) Inventors: Yuanye Wang, San Jose, CA (US); Ahmad Rezazadehreyhani, San Jose, CA (US); Jie Cui, San Jose, CA (US); Murali Narasimha, Livermore, CA (US); Amir Aminzadeh Gohari, Sunnyvale, CA (US); Yang Tang, San Jose, CA (US)

(21) Appl. No.: 19/106,756

(22) PCT Filed: Sep. 1, 2023
(86) PCT No.: PCT/US2023/073283

§ 371 Date: Feb. 26, 2025

Related U.S. Application Data
(60) Provisional application No. 63/375,145, filed on Sep. 9, 2022.

(51) Int. Cl. H04W 74/0816; H04L 5/00

(52) U.S. Cl. CPC H04W 74/0816; H04L 5/001

(57) ABSTRACT

Systems and methods for measurement gap signaling are described herein. A user equipment (UE) receives, from a network, a configuration for one or more measurement objects (MOs) at the UE and identifies any overlimit MOs (for which using per-frequency range (FR) measurement gaps would cause the UE to exceed a component carrier (CC) limitation of the UE) from among the one or more configured MOs. Upon identifying one or more such overlimit MOs, the UE sends the network a measurement gap instruction message configured to cause the network to use per-UE measurement gaps (rather than per-FR measurement gaps) corresponding to the overlimit MOs. An indication to use per-UE measurement gaps in the measurement gap instruction message may be made on a per-MO, per-CC, per-band, per FR, or per-band combination basis. In some cases, the measurement gap instruction message causes the network to use per-UE measurement gaps for all configured MOs.

### CROSS-REFERENCE TO RELATED APPLICATION

This application claims the benefit of U.S. Provisional Patent Application No. 63/375,145, filed Sep. 9, 2022, the entire disclosure of which is hereby incorporated by reference herein.

### TECHNICAL FIELD

This application relates generally to wireless communication systems, including wireless communication systems that are capable of implementing per-frequency range (FR) measurement gaps.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 c to 7125 megahertz (MHz). Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a method of a UE, according to embodiments herein.

FIG. 2 illustrates a method of a RAN, according to embodiments herein.

FIG. 3 illustrates an example architecture of a wireless communication system, according to embodiments disclosed herein.

FIG. 4 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

One or more measurement gaps may be provided at a UE. A measurement gap may be a period of time where uplink (UL) and downlink (DL) transmissions between the UE and the network relative to a radio frequency integrated circuit (RFIC) of the UE are paused (e.g., not scheduled), such that radio frequency (RF) resources of the UE corresponding to that RFIC are free to instead perform a measurement on a measurement object (MO) (e.g., on an otherwise not-used frequency, for example to monitor for potential handover conditions).

In some wireless communication networks, two types of measurement gap configurations may be defined. A first measurement gap configuration may be a “per-UE” measurement gap configuration. In some cases of UEs using a per-UE measurement gap procedure corresponding to a per-UE measurement gap configuration, it may be that a single RFIC of the UE covers both FR1 and FR2 for the UE. In such circumstances, the use of this RFIC for UL/DL signaling is paused attendant to providing the measurement gap. Accordingly, a measurement gap that is configured for an MO measurement in one of FR1 and FR2 will impact the UE's ability to simultaneously communicate on either/each of FR1 and FR2 via the (one) RFIC. Accordingly, during such a measurement gap, there may be no uplink (UL) and no downlink (DL) operation on either of FR1 or FR2 (e.g., on the entire set of FRs used by the UE).

A second measurement gap configuration may be a “per-FR” measurement gap configuration. In UE using a per-FR measurement gap procedure corresponding to a per-FR measurement gap configuration, it may be that there are multiple (e.g., in some cases two) discrete RFICs, each dedicated to covering one of FR1 and FR2, respectively, for the UE. In such circumstances, a measurement gap that is configured for an MO measurement in one of FR1 and FR2 may provide a sufficient measurement gap by pausing UL/DL transmission on only the RFIC corresponding to the FR in which the MO is found. Meanwhile, the UE continues to be able to communicate on the other of FR1 and FR2 (via the other RFIC). In other words, when using a per-FR measurement gap procedure, a measurement gap may only affect the FR for which the MO is being measured (rather than all FRs used at the UE). The use of a per-FR measurement gap configuration may be advantageous over the per-UE measurement gap configuration in at least the sense that the UE may continue performing UL and/or DL transmission an unaffected FR during a measurement gap corresponding to an affected FR.

### Gapless FR2 Measurement with no FR2 Serving Cell

It may be that some definitions and/or specifications for some wireless communications systems capable of using per-FR measurement gaps may require or use measurement gap(s) in circumstances where they are not strictly needed. For example, in various 3GPP specifications, there are several such cases regarding FR2 MO measurements (where a measurement gap on FR2 may be required even though it is not strictly necessary).

A first such case relates to an FR2 measurement in LTE standalone mode as described in 3GPP Technical Specification (TS) 36.133, v. 17.6.0 (June 2022) (hereinafter “TS 36.133”) Sections 8.1.2.4.21.1.1 and 8.20.2.1 of TS 36.133 each state: “[f]or per-FR measurement gap capable UE, when serving cells are in [Evolved Universal Terrestrial Radio Access (E-UTRA)] and measurement objects are only in FR2, UE can perform such measurements without gap.” Alternative language that may instead be used to more fully reflect cases where the measurement gap in FR2 is not needed may instead be, for example: “for per-FR measurement gap capable UE, when there is no FR2 serving cell, UE can perform such measurements without gap.” This change recognizes that in all cases where there is no FR2 serving cell, there is no need for a measurement gap covering FR2 in order to accommodate an FR2 MO (because FR2 not currently being used for data signaling). For example, in a case where current serving cells of a UE are all in E-UTRA, and there are MOs configured at the UE for both FR1 and FR2, only FR1 MOs would require usage of a measurement gap (e.g., a per-FR measurement gap in FR1), while FR2 MOs could be scheduled anywhere without the need for a measurement gap in FR2.

This change allows for comparatively faster scheduling rate of FR1 and FR2 layers in applicable cases, because they don't need to share the measurement gap. Further, this change eliminates the restrictions that FR2 synchronization signal block (SSB)-based measurement timing configuration (SMTC) windows must be aligned with the measurement gap in applicable cases.

A second such case relates to an FR2 measurement in E-UTRA-NR dual connectivity (EN-DC) mode or E-UTRA-NR dual connectivity (NE-DC) mode as described in 3GPP TS 38.133, v. 17.6.0 (June 2022) (hereinafter “TS 38.133”), Section 9.1.2, which states: “[f]or per-FR measurement gap capable UE configured with E-UTRA-NR dual connectivity or NR-E-UTRA dual connectivity, when serving cells are in E-UTRA and FR1, measurement objects are in both E-UTRA/FR1 and FR2, [i]f [master node (MN)] indicates UE that the measurement gap from MN applies to E-UTRA/FR1/FR2 serving cells, UE fulfils the per-UE measurement requirements for both E-UTRA/FR1 and FR2 measurement objects based on the measurement gap pattern configured by MN; [i]f MN indicates UE that the measurement gap from MN applies to only LTE/FR1 serving cell(s), UE fulfils the measurement requirements for FR1/LTE measurement objects based on the configured measurement gap pattern[,] [and] UE fulfils the requirements for FR2 measurement objects based on effective [measurement gap repetition period (MGRP)]=20 ms.” Alternative language that may instead be used to more fully reflect cases where the measurement gap in FR2 is not needed may instead be, for example, “for per-FR measurement gap capable UE configured with E-UTRA-NR dual connectivity or NR-E-UTRA dual connectivity, when serving cells are in E-UTRA and FR1, UE fulfils the measurement requirements for FR1/LTE measurement objects based on the configured measurement gap pattern; UE fulfils the requirements for FR2 measurement objects based on effective MGRP=20 ms.” This change recognizes that in all cases where all serving cells are in E-UTRA/FR1, there is no need for a measurement gap covering FR2 in order to accommodate an FR2 MO (because FR2 is not currently being used for data signaling). For example, in a case where current serving cells of a UE are all in E-UTRA, and there are MOs configured at the UE for both FR1 and FR2, only FR1 MOs would require usage of a (formal) measurement gap (e.g., a per-FR measurement gap in FR1), while FR2 MOs could be scheduled anywhere without the need for a (formal) measurement gap in FR2 (e.g., these may instead use the effective MGRP).

This change allows for comparatively faster scheduling rate of FR1 and FR2 layers in applicable cases, because they don't need to share the measurement gap. Further, this change eliminates the restrictions that FR2 SMTC windows must be aligned with measurement gap in applicable cases.

### Per-Frequency Range Measurement Gap Capability Improvement

In some cases, independent measurement gap UE capability (e.g., a capability of using per-FR measurement gaps) is specified in a per-UE way-in other words, the UE is capable of indicating to the network whether it supports (or not) the use of per-FR measurement gaps. This indication may be made without regard to particular band combinations and/or a target to-be-measured carrier.

Under certain UE implementations, if the UE shares internal resources (e.g., memory, or processing resources) between data/control and measurement, it can be problematic if the UE is configured to measure a CC when it already has many serving CCs. Accordingly, cases have been identified where it is desirable that a UE that is capable of per-FR measurement gap “falls back” to a per-UE measurement gap configuration (e.g., where UL/DL transmission is paused across all the (e.g., multiple) RFICs of the UE during the measurement gap).

More generally stated, it has been identified that there may be particular circumstances (e.g., corresponding to a saturation of one or more UE baseband capabilities) where a UE that is otherwise capable using a per-FR measurement gap configuration instead should use/fall back to a per-UE measurement gap configuration.

A UE's baseband capability may be controlled by and/or correspond to, for example, a buffer size used at the UE and/or a processing capability at the UE, etc. A number of simultaneous CCs that a UE is able to use within such a baseband capability may be referred to herein as a “CC limitation” of the UE. Accordingly, a CC limitation of the UE may (also) be understood to be controlled by and/or correspond to the buffer size used at the UE, the processing capability at the UE, etc. It is contemplated that in some cases, a CC limitation may be in terms of a maximum number of active serving CCs across all FRs of the UE (e.g., between FR1 and FR2).

Consider a first case where a UE has two separate RFICs, one each for FR1 and FR2. Further, assume the UE has been configured with 9 component carriers (CCs), all of which belong to FR2. Then, the UE is configured to measure an FR1 MO.

According to the per-FR measurement gap configuration as described above, this case corresponds to a behavior where the UE does not need to stop UL/DL transmission on FR2 in order to perform the measurement corresponding to the FR1 MO, due to FR1 having a separate RFIC for FR2. Accordingly, the UE might be expected to continue to perform UL/DL communication on the 9 active CC on FR2 while simultaneously measuring the FR1 MO (e.g., during a per-FR measurement gap for FR1).

However, it may be that a UE's baseband capability is limited to supporting only up to 9 simultaneous CCs. Due to this baseband capability limitation, the UE accordingly cannot both use the 9 active CC on FR2 while simultaneously measuring the FR1 MO without exceeding the CC limitation (because this would effectively be the simultaneous use of a 10th CC).

Thus, to allow for the measurement corresponding to the FR1 MO, it may accordingly be advantageous to allow the UE to instead use a per-UE measurement gap configuration in this case, which would allow the UE to stop the active use of all CCs at the UE (e.g., across each of FR1 and FR2) corresponding to the time of the per-UE measurement gap such that the UE has the capability of measuring the FR1 MO.

It is also generally contemplated that, in some circumstances, a UE capable of per-FR measurement gap procedures that is at a CC limitation and is to perform an MO measurement may in any event be able to use per-FR measurement gap procedures (rather than falling back to a use of a per-UE measurement gap as has been described) without exceeding the CC limitation. For example, it may be that the UE that is to perform a MO measurement is at a maximum limitation of active CCs across all FRs of the UE, but that one or more of the active CCs are in FR1 and one or more active CCs are in FR2. The use of per-FR measurement gap procedure to perform the MO measurement in such a case will not be problematic. This is because when the UE uses a measurement gap to pause the use of one of the RFIC corresponding to the one of FR1 or FR2 that corresponds to the MO measurement, at least the use of one CC will be paused (in whatever case). In such circumstances, the UE will at no point exceed its cross-FR CC limitation in order to perform the MO measurement.

Indications from a UE to the network (e.g., to the RAN) regarding where and whether the UE can use per-FR measurement gaps versus per-UE measurement gaps as corresponding to one or more MOs configured at the UE by the network are now discussed.

A network may provide the UE with a configuration of one or more MOs that are to be measured by the UE. These MOs may correspond to, for example, measurements on CCs that are not presently active CCs of the UE (e.g., to evaluate these CCs for handover purposes, etc., as has been described).

The UE may check each configured MO to determine whether the use of a per-FR measurement gap to perform the measurement of the applicable CC for the MO will cause the UE to exceed a CC limitation. For example, the UE may check, at the time for measuring each MO, whether the UE is using a total number of CCs equal to the CC limitation in an FR that is other than the FR for the configured MO. If so, the UE determines that the MO is an “overlimit MO” (an MO for which the use of a per-FR measurement gap would cause the UE to exceed a CC limitation).

In the case that one or more overlimit MOs are identified from the one or more MOs configured by the network, the UE sends the network a measurement gap instruction message that is configured to cause the network to use per-UE measurement gaps corresponding to any overlimit MOs. For example, the measurement gap instruction message may be configured to cause the network to not perform scheduling on any FR used by the UE during the time(s) for measuring the overlimit MO(s).

In a first case, a measurement gap instruction message includes indications for each of the one or more MOs configured by the network. Each such indication indicates whether a per-FR measurement gap can be used corresponding to the applicable MO. The UE may configure the measurement gap instruction message to indicate that per-FR measurement gap(s) corresponding the one or more overlimit MOs from among the one or more MOs configured by the network cannot be used. Further, the UE determines to use (at the UE) a per-UE measurement gap corresponding to each of the overlimit MOs.

Upon receiving the measurement gap instruction message, for each MO where it is indicated that a per-FR measurement gap may be used, the network may use a per-FR measurement gap corresponding to that MO. For each MO where it is indicated that a per-FR measurement gap cannot be used, the network may use a per-UE measurement gap corresponding to that MO. Accordingly, each of the overlimit MOs corresponds to the use of a per-UE measurement gap at the network.

In a second case, a measurement gap instruction message includes indications for each of one or more CCs used by the one or more MOs configured by the network. Each such indication indicates whether per-FR measurement gap(s) can be used corresponding to the applicable CC. The UE may identify, from among the one or more CCs used by the one or more MOs configured by the network, any CC(s) that are used by any of the one or more overlimit MOs and configure the measurement gap instruction message to indicate that per-FR measurement gaps corresponding to such CC(s) cannot be used. Further, the UE determines to use (at the UE) per-UE measurement gap(s) corresponding to MO(s) of each of these CC(s).

Upon receiving the measurement gap instruction message, for each CC where it is indicated that per-FR measurement gaps cannot be used, the network may use per-UE measurement gap(s) corresponding to MO(s) using that CC. Accordingly, each of the overlimit MOs corresponds to the use of a per-UE measurement gap at the network. For each CC where it is indicated that per-FR measurement gaps may be used, the network may use a per-FR measurement gap corresponding to MOs using that CC.

In a third case, a measurement gap instruction message includes indications for each of one or more bands used by the one or more MOs configured by the network. Each such indication indicates whether per-FR measurement gap(s) can be used corresponding to the applicable band. The UE may identify, from among the one or more bands used by the one or more MOs configured by the network, any band(s) that are used by any of the one or more overlimit MOs and configure the measurement gap instruction message to indicate that per-FR measurement gaps corresponding to such band(s) cannot be used. Further, the UE determines to use (at the UE) per-UE measurement gap(s) corresponding to MO(s) of each of these band(s).

Upon receiving the measurement gap instruction message, for each band where it is indicated that per-FR measurement gaps cannot be used, the network may use per-UE measurement gap(s) corresponding to MO(s) using that band. Accordingly, each of the overlimit MOs corresponds to the use of a per-UE measurement gap at the network. For each band where it is indicated that per-FR measurement gaps may be used, the network may use per-FR measurement gap(s) corresponding to MO(s) using that band.

In a fourth case, a measurement gap instruction message includes indications for each of one or more FRs used by the one or more MOs configured by the network. Each such indication indicates whether per-FR measurement gap(s) can be used corresponding to the applicable FR. The UE may identify, from among the one or more FRs used by the one or more MOs configured by the network, any FR(s) that are used by any of the one or more overlimit MOs and configure the measurement gap instruction message to indicate that per-FR measurement gaps corresponding to such FR(s) cannot be used. Further, the UE determines to use (at the UE) per-UE measurement gap(s) corresponding to MO(s) of each of these FR(s).

Upon receiving the measurement gap instruction message, for each FR where it is indicated that per-FR measurement gaps cannot be used, the network may use per-UE measurement gap(s) corresponding to MO(s) using that FR. Accordingly, each of the overlimit MOs corresponds to the use of a per-UE measurement gap at the network. For each FR where it is indicated that per-FR measurement gaps may be used, the network may use a per-FR measurement gap(s) corresponding to MO(s) using that FR.

In a fifth case, a measurement gap instruction message includes indications for each of one or more band combinations used by the one or more MOs configured by the network. Each such indication indicates whether a per-FR measurement gap(s) can be used corresponding to the applicable band combination. The UE may identify, from among the one or more band combinations used by the one or more MOs configured by the network, any band combination(s) that are used by any of the one or more overlimit MOs and configure the measurement gap instruction message to indicate that per-FR measurement gaps corresponding to such band combination(s) cannot be used. Further, the UE determines to use (at the UE) per-UE measurement gap(s) corresponding to MO(s) of each of these band combination(s).

Upon receiving the measurement gap instruction message, for each band combination where it is indicated that per-FR measurement gap(s) cannot be used, the network may use per-UE measurement gap(s) corresponding to MO(s) using that band combination. Accordingly, each of the overlimit MOs corresponds to the use of a per-UE measurement gap at the network. For each band combination where it is indicated that per-FR measurement gaps may be used, the network may use per-FR measurement gap(s) corresponding to MO(s) using that band combination.

In a sixth case, a measurement gap instruction message may indicate to the network that the UE wants to use per-UE measurement gaps for all of the one or more MOs configured by the network. It may be that the UE is configured to make such an indication in response to an identification of any overlimit MO from among the one or more MOs configured by the network. Accordingly, upon identifying the one or more overlimit MOs from among the one or more MOs configured by the network as described above, the UE makes this indication in the measurement gap instruction message. Further, the UE determines to use (at the UE) a per-UE measurement gap corresponding to each of the MOs configured by the network.

Upon receiving the measurement gap instruction message, the network accordingly uses a per-UE measurement gap corresponding to each of the MOs that it configured. Accordingly, each of the overlimit MOs corresponds to the use of a per-UE measurement gap at the network.

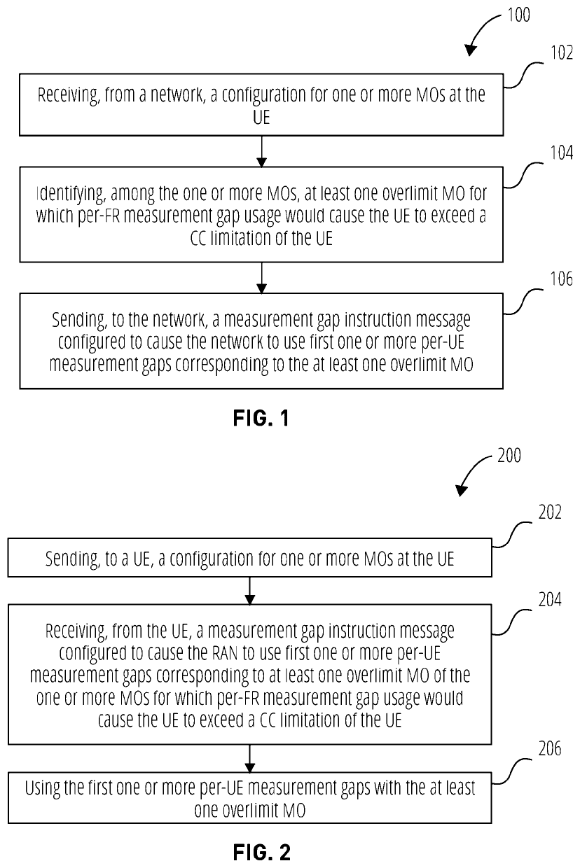

FIG. 1 illustrates a method 100 of a UE, according to embodiments herein. The method 100 includes receiving 102, from a network, a configuration for one or more MOs at the UE.

The method 100 further includes identifying 104, among the one or more MOs, at least one overlimit MO for which per-FR measurement gap usage would cause the UE to exceed a CC limitation of the UE.

The method 100 further includes sending 106, to the network, a measurement gap instruction message configured to cause the network to use first one or more per-UE measurement gaps corresponding to the at least one overlimit MO.

In some embodiments of the method 100, the measurement gap instruction message comprises one or more indications corresponding to the one or more MOs, the one or more indications indicating whether a per-FR measurement gap corresponding to one of the one or more MOs can be used, and at least one of the one or more indications that corresponds to the at least one overlimit MO indicates that a corresponding per-FR measurement gap cannot be used.

In some embodiments of the method 100, the measurement gap instruction message comprises one or more indications corresponding to one or more CCs used by the one or more MOs, the one or more indications indicating whether a per-FR measurement gap corresponding to one of the one or more CCs can be used, and at least one of the one or more indications that corresponds to at least one of the one or more CCs that are used by the at least one overlimit MO indicates that a corresponding per-FR measurement gap cannot be used.

In some embodiments of the method 100, the measurement gap instruction message comprises one or more indications corresponding to one or more bands used by the one or more MOs, the one or more indications indicating whether a per-FR measurement gap corresponding to the one or more bands can be used, and at least one of the one or more indications that corresponds to at least one of the one or more bands that are used by the at least one overlimit MO indicates that a corresponding per-FR measurement gap cannot be used.

In some embodiments of the method 100, the measurement gap instruction message comprises one or more indications corresponding to one or more FRs used by the one or more MOs, the one or more indications indicating whether a per-FR measurement gap corresponding to the one or more FRs can be used, and at least one of the one or more indications that corresponds to at least one of the one or more FRs that are used by the at least one overlimit MO indicates that a corresponding per-FR measurement gap cannot be used.

In some embodiments of the method 100, the measurement gap instruction message comprises one or more indications corresponding to one or more band combinations used by the one or more MOs, the one or more indications indicating whether a per-FR measurement gap corresponding to the one or more band combinations can be used, and at least one of the one or more indications that corresponds to at least one of the one or more band combinations that are used by the at least one overlimit MO indicates that a corresponding per-FR measurement gap cannot be used.

In some embodiments of the method 100, the UE configures the measurement gap instruction message to further cause the network to use second one or more per-UE measurement gaps for each of the one or more MOs that is not an overlimit MO in response to the identifying the one or more overlimit MOs.

In some embodiments of the method 100, the CC limitation is across all FRs used by the UE.

Embodiments contemplated herein include an apparatus comprising means to perform one or more elements of the method 100. This apparatus may be, for example, an apparatus of a UE (such as a wireless device 402 that is a UE, as described herein).

Embodiments contemplated herein include one or more non-transitory computer-readable media comprising instructions to cause an electronic device, upon execution of the instructions by one or more processors of the electronic device, to perform one or more elements of the method 100. This non-transitory computer-readable media may be, for example, a memory of a UE (such as a memory 406 of a wireless device 402 that is a UE, as described herein).

Embodiments contemplated herein include an apparatus comprising logic, modules, or circuitry to perform one or more elements of the method 100. This apparatus may be, for example, an apparatus of a UE (such as a wireless device 402 that is a UE, as described herein).

Embodiments contemplated herein include an apparatus comprising: one or more processors and one or more computer-readable media comprising instructions that, when executed by the one or more processors, cause the one or more processors to perform one or more elements of the method 100. This apparatus may be, for example, an apparatus of a UE (such as a wireless device 402 that is a UE, as described herein).

Embodiments contemplated herein include a signal as described in or related to one or more elements of the method 100.

Embodiments contemplated herein include a computer program or computer program product comprising instructions, wherein execution of the program by a processor is to cause the processor to carry out one or more elements of the method 100. The processor may be a processor of a UE (such as a processor(s) 404 of a wireless device 402 that is a UE, as described herein). These instructions may be, for example, located in the processor and/or on a memory of the UE (such as a memory 406 of a wireless device 402 that is a UE, as described herein).

FIG. 2 illustrates a method 200 of a RAN, according to embodiments herein. The method 200 includes sending 202, to a UE, a configuration for one or more MOs at the UE.

The method 200 further includes receiving 204, from the UE, a measurement gap instruction message configured to cause the RAN to use first one or more per-UE measurement gaps corresponding to at least one overlimit MO of the one or more MOs for which per-FR measurement gap usage would cause the UE to exceed a CC limitation of the UE.

The method 200 further includes using 206 the first one or more per-UE measurement gaps with the at least one overlimit MO.

In some embodiments of the method 200, the measurement gap instruction message comprises one or more indications corresponding to the one or more MOs, the one or more indications indicating whether a per-FR measurement gap corresponding to one of the one or more MOs can be used, and at least one of the one or more indications that corresponds to the at least one overlimit MO indicates that a corresponding per-FR measurement gap cannot be used.

In some embodiments of the method 200, the measurement gap instruction message comprises one or more indications corresponding to one or more CCs used by the one or more MOs, the one or more indications indicating whether a per-FR measurement gap corresponding to one of the one or more CCs can be used, and at least one of the one or more indications that corresponds to at least one of the one or more CCs that are used by the at least one overlimit MO indicates that a corresponding per-FR measurement gap cannot be used.

In some embodiments of the method 200, the measurement gap instruction message comprises one or more indications corresponding to one or more bands used by the one or more MOs, the one or more indications indicating whether a per-FR measurement gap corresponding to the one or more bands can be used, and at least one of the one or more indications that corresponds to at least one of the one or more bands that are used by the at least one overlimit MO indicates that a corresponding per-FR measurement gap cannot be used.

In some embodiments of the method 200, the measurement gap instruction message comprises one or more indications corresponding to one or more FRs used by the one or more MOs, the one or more indications indicating whether a per-FR measurement gap corresponding to the one or more FRs can be used, and at least one of the one or more indications that corresponds to at least one of the one or more FRs that are used by the at least one overlimit MO indicates that a corresponding per-FR measurement gap cannot be used.

In some embodiments of the method 200, the measurement gap instruction message comprises one or more indications corresponding to one or more band combinations used by the one or more MOs, the one or more indications indicating whether a per-FR measurement gap corresponding to the one or more band combinations can be used, and at least one of the one or more indications that corresponds to at least one of the one or more band combinations that are used by the at least one overlimit MO indicates that a corresponding per-FR measurement gap cannot be used.

In some embodiments of the method 200, the measurement gap instruction message is configured to further cause the RAN to use second one or more per-UE measurement gaps for each of the one or more MOs that is not an overlimit MO; and the method 200 further comprises using the second one or more per-UE measurement gaps with each of the one or more MOs that is not an overlimit MO.

In some embodiments of the method 200, the CC limitation is across all FRs used by the UE.

Embodiments contemplated herein include an apparatus comprising means to perform one or more elements of the method 200. This apparatus may be, for example, an apparatus of a base station (such as a network device 418 that is a base station, as described herein).

Embodiments contemplated herein include one or more non-transitory computer-readable media comprising instructions to cause an electronic device, upon execution of the instructions by one or more processors of the electronic device, to perform one or more elements of the method 200. This non-transitory computer-readable media may be, for example, a memory of a base station (such as a memory 422 of a network device 418 that is a base station, as described herein).

Embodiments contemplated herein include an apparatus comprising logic, modules, or circuitry to perform one or more elements of the method 200. This apparatus may be, for example, an apparatus of a base station (such as a network device 418 that is a base station, as described herein).

Embodiments contemplated herein include an apparatus comprising: one or more processors and one or more computer-readable media comprising instructions that, when executed by the one or more processors, cause the one or more processors to perform one or more elements of the method 200. This apparatus may be, for example, an apparatus of a base station (such as a network device 418 that is a base station, as described herein).

Embodiments contemplated herein include a signal as described in or related to one or more elements of the method 200.

Embodiments contemplated herein include a computer program or computer program product comprising instructions, wherein execution of the program by a processing element is to cause the processing element to carry out one or more elements of the method 200. The processor may be a processor of a base station (such as a processor(s) 420 of a network device 418 that is a base station, as described herein).

These instructions may be, for example, located in the processor and/or on a memory of the base station (such as a memory 422 of a network device 418 that is a base station, as described herein).

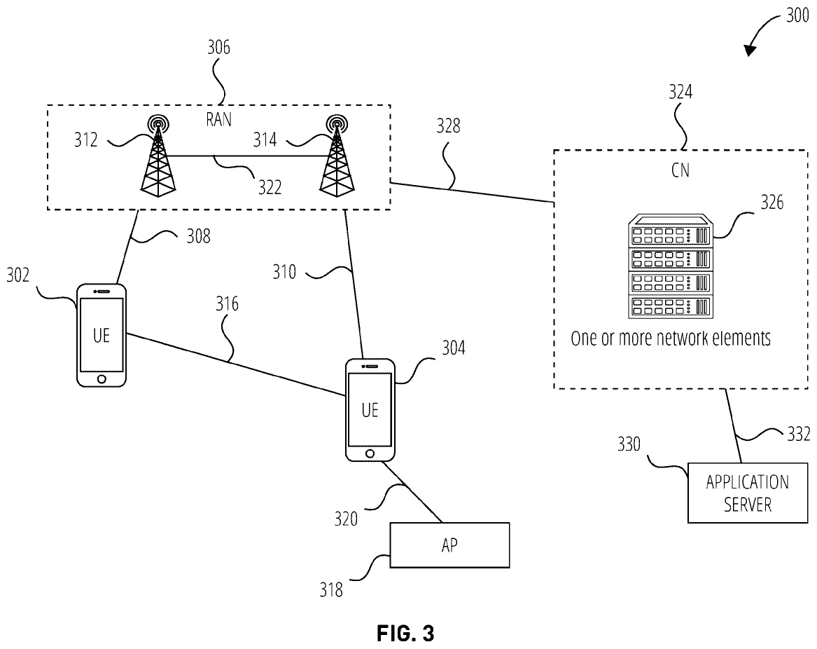

FIG. 3 illustrates an example architecture of a wireless communication system 300, according to embodiments disclosed herein. The following description is provided for an example wireless communication system 300 that operates in conjunction with the LTE system standards and/or 5G or NR system standards as provided by 3GPP technical specifications.

As shown by FIG. 3, the wireless communication system 300 includes UE 302 and UE 304 (although any number of UEs may be used). In this example, the UE 302 and the UE 304 are illustrated as smartphones (e.g., handheld touchscreen mobile computing devices connectable to one or more cellular networks), but may also comprise any mobile or non-mobile computing device configured for wireless communication.

The UE 302 and UE 304 may be configured to communicatively couple with a RAN 306. In embodiments, the RAN 306 may be NG-RAN, E-UTRAN, etc. The UE 302 and UE 304 utilize connections (or channels) (shown as connection 308 and connection 310, respectively) with the RAN 306, each of which comprises a physical communications interface. The RAN 306 can include one or more base stations (such as base station 312 and base station 314) that enable the connection 308 and connection 310.

In this example, the connection 308 and connection 310 are air interfaces to enable such communicative coupling, and may be consistent with RAT(s) used by the RAN 306, such as, for example, an LTE and/or NR.

In some embodiments, the UE 302 and UE 304 may also directly exchange communication data via a sidelink interface 316. The UE 304 is shown to be configured to access an access point (shown as AP 318) via connection 320. By way of example, the connection 320 can comprise a local wireless connection, such as a connection consistent with any IEEE 802.11 protocol, wherein the AP 318 may comprise a Wi-Fi® router. In this example, the AP 318 may be connected to another network (for example, the Internet) without going through a CN 324.

In embodiments, the UE 302 and UE 304 can be configured to communicate using orthogonal frequency division multiplexing (OFDM) communication signals with each other or with the base station 312 and/or the base station 314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 312 or base station 314 may be implemented as one or more software entities running on server computers as part of a virtual network. In addition, or in other embodiments, the base station 312 or base station 314 may be configured to communicate with one another via interface 322. In embodiments where the wireless communication system 300 is an LTE system (e.g., when the CN 324 is an EPC), the interface 322 may be an X2 interface. The X2 interface may be defined between two or more base stations (e.g., two or more eNBs and the like) that connect to an EPC, and/or between two eNBs connecting to the EPC. In embodiments where the wireless communication system 300 is an NR system (e.g., when CN 324 is a 5GC), the interface 322 may be an Xn interface. The Xn interface is defined between two or more base stations (e.g., two or more gNBs and the like) that connect to 5GC, between a base station 312 (e.g., a gNB) connecting to 5GC and an eNB, and/or between two eNBs connecting to 5GC (e.g., CN 324).

The RAN 306 is shown to be communicatively coupled to the CN 324. The CN 324 may comprise one or more network elements 326, which are configured to offer various data and telecommunications services to customers/subscribers (e.g., users of UE 302 and UE 304) who are connected to the CN 324 via the RAN 306. The components of the CN 324 may be implemented in one physical device or separate physical devices including components to read and execute instructions from a machine-readable or computer-readable medium (e.g., a non-transitory machine-readable storage medium).

In embodiments, the CN 324 may be an EPC, and the RAN 306 may be connected with the CN 324 via an S1 interface 328. In embodiments, the SI interface 328 may be split into two parts, an S1 user plane (S1-U) interface, which carries traffic data between the base station 312 or base station 314 and a serving gateway (S-GW), and the S1-MME interface, which is a signaling interface between the base station 312 or base station 314 and mobility management entities (MMEs).

In embodiments, the CN 324 may be a 5GC, and the RAN 306 may be connected with the CN 324 via an NG interface 328. In embodiments, the NG interface 328 may be split into two parts, an NG user plane (NG-U) interface, which carries traffic data between the base station 312 or base station 314 and a user plane function (UPF), and the S1 control plane (NG-C) interface, which is a signaling interface between the base station 312 or base station 314 and access and mobility management functions (AMFs).

Generally, an application server 330 may be an element offering applications that use internet protocol (IP) bearer resources with the CN 324 (e.g., packet switched data services). The application server 330 can also be configured to support one or more communication services (e.g., VoIP sessions, group communication sessions, etc.) for the UE 302 and UE 304 via the CN 324. The application server 330 may communicate with the CN 324 through an IP communications interface 332.

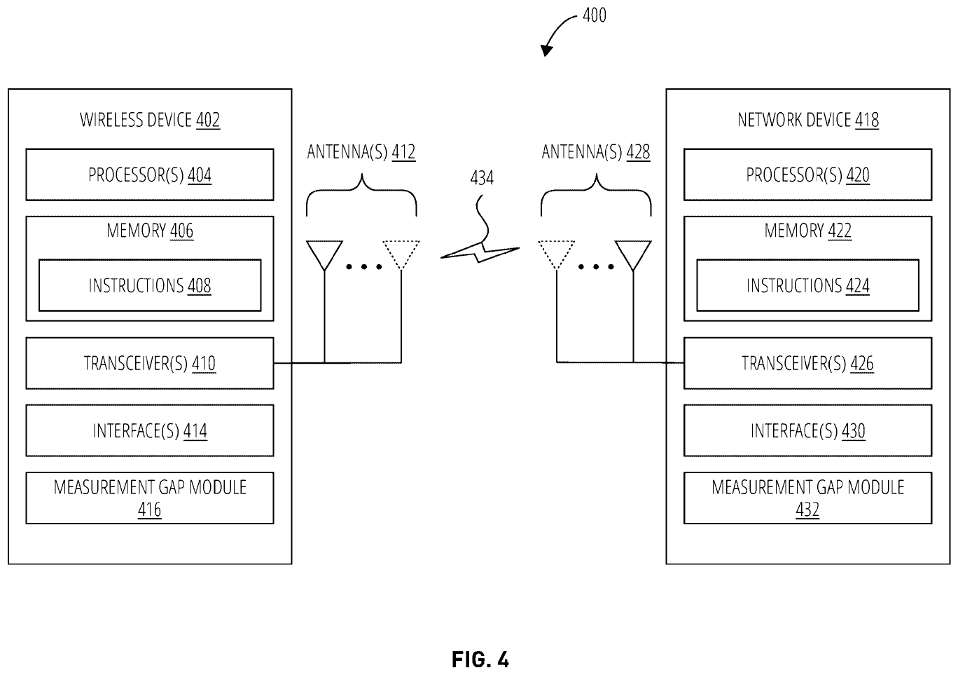

FIG. 4 illustrates a system 400 for performing signaling 434 between a wireless device 402 and a network device 418, according to embodiments disclosed herein. The system 400 may be a portion of a wireless communications system as herein described. The wireless device 402 may be, for example, a UE of a wireless communication system. The network device 418 may be, for example, a base station (e.g., an eNB or a gNB) of a wireless communication system.

The wireless device 402 may include one or more processor(s) 404. The processor(s) 404 may execute instructions such that various operations of the wireless device 402 are performed, as described herein. The processor(s) 404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 402 may include a memory 406. The memory 406 may be a non-transitory computer-readable storage medium that stores instructions 408 (which may include, for example, the instructions being executed by the processor(s) 404). The instructions 408 may also be referred to as program code or a computer program. The memory 406 may also store data used by, and results computed by, the processor(s) 404.

The wireless device 402 may include one or more transceiver(s) 410 that may include radio frequency (RF) transmitter and/or receiver circuitry that use the antenna(s) 412 of the wireless device 402 to facilitate signaling (e.g., the signaling 434) to and/or from the wireless device 402 with other devices (e.g., the network device 418) according to corresponding RATs.

The wireless device 402 may include one or more antenna(s) 412 (e.g., one, two, four, or more). For embodiments with multiple antenna(s) 412, the wireless device 402 may leverage the spatial diversity of such multiple antenna(s) 412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 402 may be accomplished according to precoding (or digital beamforming) that is applied at the wireless device 402 that multiplexes the data streams across the antenna(s) 412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 402 may implement analog beamforming techniques, whereby phases of the signals sent by the antenna(s) 412 are relatively adjusted such that the (joint) transmission of the antenna(s) 412 can be directed (this is sometimes referred to as beam steering).

The wireless device 402 may include one or more interface(s) 414. The interface(s) 414 may be used to provide input to or output from the wireless device 402. For example, a wireless device 402 that is a UE may include interface(s) 414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 410/antenna(s) 412 already described) that allow for communication between the UE and other devices and may operate according to known protocols (e.g., Wi-Fi®, Bluetooth®, and the like).

The wireless device 402 may include a measurement gap module 416. The measurement gap module 416 may be implemented via hardware, software, or combinations thereof. For example, the measurement gap module 416 may be implemented as a processor, circuit, and/or instructions 408 stored in the memory 406 and executed by the processor(s) 404. In some examples, the measurement gap module 416 may be integrated within the processor(s) 404 and/or the transceiver(s) 410. For example, the measurement gap module 416 may be implemented by a combination of software components (e.g., executed by a DSP or a general processor) and hardware components (e.g., logic gates and circuitry) within the processor(s) 404 or the transceiver(s) 410.

The measurement gap module 416 may be used for various aspects of the present disclosure, for example, aspects of FIG. 1. The measurement gap module 416 is configured to implement per-FR and/or per-UE measurement gaps at the UE in the manner as has been described herein.

The network device 418 may include one or more processor(s) 420. The processor(s) 420 may execute instructions such that various operations of the network device 418 are performed, as described herein. The processor(s) 420 may include one or more baseband processors implemented using, for example, a CPU, a DSP, an ASIC, a controller, an FPGA device, another hardware device, a firmware device, or any combination thereof configured to perform the operations described herein.

The network device 418 may include a memory 422. The memory 422 may be a non-transitory computer-readable storage medium that stores instructions 424 (which may include, for example, the instructions being executed by the processor(s) 420). The instructions 424 may also be referred to as program code or a computer program. The memory 422 may also store data used by, and results computed by, the processor(s) 420.

The network device 418 may include one or more transceiver(s) 426 that may include RF transmitter and/or receiver circuitry that use the antenna(s) 428 of the network device 418 to facilitate signaling (e.g., the signaling 434) to and/or from the network device 418 with other devices (e.g., the wireless device 402) according to corresponding RATs.

The network device 418 may include one or more antenna(s) 428 (e.g., one, two, four, or more). In embodiments having multiple antenna(s) 428, the network device 418 may perform MIMO, digital beamforming, analog beamforming, beam steering, etc., as has been described.

The network device 418 may include one or more interface(s) 430. The interface(s) 430 may be used to provide input to or output from the network device 418. For example, a network device 418 that is a base station may include interface(s) 430 made up of transmitters, receivers, and other circuitry (e.g., other than the transceiver(s) 426/antenna(s) 428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 418 may include a measurement gap module 432. The measurement gap module 432 may be implemented via hardware, software, or combinations thereof. For example, the measurement gap module 432 may be implemented as a processor, circuit, and/or instructions 424 stored in the memory 422 and executed by the processor(s) 420. In some examples, the measurement gap module 432 may be integrated within the processor(s) 420 and/or the transceiver(s) 426. For example, the measurement gap module 432 may be implemented by a combination of software components (e.g., executed by a DSP or a general processor) and hardware components (e.g., logic gates and circuitry) within the processor(s) 420 or the transceiver(s) 426.

The measurement gap module 432 may be used for various aspects of the present disclosure, for example, aspects of FIG. 2. The measurement gap module 432 is configured to implement per-FR and/or per-UE measurement gaps at the network in the manner as has been described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, a configuration for one or more measurement objects (MOS) at the UE;
identifying, among the one or more MOs, at least one overlimit MO for which per-frequency range (FR) measurement gap usage would cause the UE to exceed a component carrier (CC) limitation of the UE; and
sending, to the network, a measurement gap instruction message configured to cause the network to use first one or more per-UE measurement gaps corresponding to the at least one overlimit MO.

2. The method of claim 1, wherein:
the measurement gap instruction message comprises one or more indications corresponding to the one or more MOs, the one or more indications indicating whether a per-FR measurement gap corresponding to one of the one or more MOs can be used, and
at least one of the one or more indications that corresponds to the at least one overlimit MO indicates that a corresponding per-FR measurement gap cannot be used.

3. The method of claim 1, wherein:
the measurement gap instruction message comprises one or more indications corresponding to one or more CCs used by the one or more MOs, the one or more indications indicating whether a per-FR measurement gap corresponding to one of the one or more CCs can be used, and
at least one of the one or more indications that corresponds to at least one of the one or more CCs that are used by the at least one overlimit MO indicates that a corresponding per-FR measurement gap cannot be used.

4. The method of claim 1, wherein:
the measurement gap instruction message comprises one or more indications corresponding to one or more bands used by the one or more MOs, the one or more indications indicating whether a per-FR measurement gap corresponding to the one or more bands can be used, and
at least one of the one or more indications that corresponds to at least one of the one or more bands that are used by the at least one overlimit MO indicates that a corresponding per-FR measurement gap cannot be used.

5. The method of claim 1, wherein:
the measurement gap instruction message comprises one or more indications corresponding to one or more FRs used by the one or more MOs, the one or more indications indicating whether a per-FR measurement gap corresponding to the one or more FRs can be used, and
at least one of the one or more indications that corresponds to at least one of the one or more FRs that are used by the at least one overlimit MO indicates that a corresponding per-FR measurement gap cannot be used.

6. The method of claim 1, wherein:
the measurement gap instruction message comprises one or more indications corresponding to one or more band combinations used by the one or more MOs, the one or more indications indicating whether a per-FR measurement gap corresponding to the one or more band combinations can be used, and
at least one of the one or more indications that corresponds to at least one of the one or more band combinations that are used by the at least one overlimit MO indicates that a corresponding per-FR measurement gap cannot be used.

7. The method of claim 1, wherein the UE configures the measurement gap instruction message to further cause the network to use second one or more per-UE measurement gaps for each of the one or more MOs that is not an overlimit MO in response to the identifying the one or more overlimit MOs.

8. The method of claim 1, wherein the CC limitation is across all FRs used by the UE.

9. A method of a radio access network (RAN), comprising:
sending, to a user equipment (UE), a configuration for one or more measurement objects (MOs) at the UE;
receiving, from the UE, a measurement gap instruction message configured to cause the RAN to use first one or more per-UE measurement gaps corresponding to at least one overlimit MO of the one or more MOs for which per-frequency range (FR) measurement gap usage would cause the UE to exceed a component carrier (CC) limitation of the UE; and
using the first one or more per-UE measurement gaps with the at least one overlimit MO.

10. The method of claim 9, wherein:
the measurement gap instruction message comprises one or more indications corresponding to the one or more MOs, the one or more indications indicating whether a per-FR measurement gap corresponding to one of the one or more MOs can be used, and
at least one of the one or more indications that corresponds to the at least one overlimit MO indicates that a corresponding per-FR measurement gap cannot be used.

11. The method of claim 9, wherein:
the measurement gap instruction message comprises one or more indications corresponding to one or more CCs used by the one or more MOs, the one or more indications indicating whether a per-FR measurement gap corresponding to one of the one or more CCs can be used, and
at least one of the one or more indications that corresponds to at least one of the one or more CCs that are used by the at least one overlimit MO indicates that a corresponding per-FR measurement gap cannot be used.

12. The method of claim 9, wherein:
the measurement gap instruction message comprises one or more indications corresponding to one or more bands used by the one or more MOs, the one or more indications indicating whether a per-FR measurement gap corresponding to the one or more bands can be used, and
at least one of the one or more indications that corresponds to at least one of the one or more bands that are used by the at least one overlimit MO indicates that a corresponding per-FR measurement gap cannot be used.

13. The method of claim 9, wherein:
the measurement gap instruction message comprises one or more indications corresponding to one or more FRs used by the one or more MOs, the one or more indications indicating whether a per-FR measurement gap corresponding to the one or more FRs can be used, and
at least one of the one or more indications that corresponds to at least one of the one or more FRs that are used by the at least one overlimit MO indicates that a corresponding per-FR measurement gap cannot be used.

14. The method of claim 9, wherein:
the measurement gap instruction message comprises one or more indications corresponding to one or more band combinations used by the one or more MOs, the one or more indications indicating whether a per-FR measurement gap corresponding to the one or more band combinations can be used, and
at least one of the one or more indications that corresponds to at least one of the one or more band combinations that are used by the at least one overlimit MO indicates that a corresponding per-FR measurement gap cannot be used.

15. The method of claim 9, wherein:
the measurement gap instruction message is configured to further cause the RAN to use second one or more per-UE measurement gaps for each of the one or more MOs that is not an overlimit MO, and
the method further comprises using the second one or more per-UE measurement gaps with each of the one or more MOs that is not the overlimit MO.

16. The method of claim 9, wherein the CC limitation is across all FRs used by the UE.

17-19. (canceled)
